(19) United States
(12) Patent Application Publication
(10) Pub. No.: US 2006/0285246 A1
(43) Pub. Date: Dec. 21, 2006

(54) Disc Drive Capable Of Decreasing Noise

(76) Inventor: Chung-Ping Chuang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/419,764

(22) Filed: May 23, 2006

(30) Foreign Application Priority Data
May 23, 2005 (TW) 094116706

(51) Int. Cl. G11B 33/14

(52) U.S. Cl. 360/97.02

(57) ABSTRACT

A disc drive includes a housing, a workbench, and a panel. The housing includes an opening, a protection plane, a baffler plane formed on a side of disc ejection and extended from one edge of the protection plane, a support plane extended from the baffler plane, and a flange extended from the support plane. The workbench is installed inside the housing for performing corresponding functions. The panel includes a first fillister corresponding to the support plane and a second fillister corresponding to the flange on the side of disc ejection for covering the opening of the housing. A length of the support plane is approximately equal to a width of the protection plane, and neither the baffler plane nor the support plane include a hole

### BACKGROUND OF THE INVENTION

1. Field of the Invention

The present invention provides a disc drive capable of decreasing noise, and more particularly, a disc drive having a housing without a hole for insulating wind shear noise generated by rotation of the disc drive.

2. Description of the Prior Art

As technology of optoelectronics highly develops, an operating speed of a disc drive becomes higher, which generates more noise accordingly. In a prior art disc drive, a package case of the disc drive must includes holes for attaching a panel to the disc drive, so that noise generated by operation of the disc drive cannot be soundproofed.

For example, please refer to FIG. 1, which illustrates a schematic diagram of a prior art disc drive 100. To be precise, FIG. 1 shows corresponding positions of a workbench 101, a housing 102, and a panel 104 in the disc drive 100. The housing 102 is usually made of metal, and utilized for wrapping the top and laterals of the workbench 101. The panel 104 is usually made of plastic, fixed in front of the disc drive 100, and includes a port for injecting or ejecting a disc and a plurality of switches. By protection of the housing 102 and the panel 104, the disc drive 100 can prevent dust from getting into the workbench 101 and can insulate operating noise. Moreover, a bad disc may be broken and become fragments when being rotated at a high speed, and the housing 102 and the panel 104 can prevent the fragments from flying out from the disc drive 100. In order to fix the panel 104 on the housing 102, the housing 102 must include holes 106 and 108. The panel 104 includes hooks 110 and 112 corresponding to the holes 106 and 108 for fixing on the housing 102. Please refer to FIG. 2 further, which illustrates a cross-sectional diagram of the disc drive 100 along with centers of the hole 108 and the hook 112. As shown in FIG. 2, the hook 112 passes through the hole 108 to fix on the housing 102.

When the workbench 101 rotates a disc at a high speed, the disc generates loud wind shear noise. Since the holes 106 and 108 are about located in a rotational plane of the disc in the workbench 101, wind shear noise generated by the disc will be transmitted out from the holes 106 and 108. Meanwhile, since the hooks 110 and 112 of the panel 104 pass through the holes 106 and 108 to fix on the housing 102, wind generated by the rotated disc hits the hooks 110 and 112 and the holes 106 and 108 generates more noise. Moreover, a bad disc may be broken and become fragments when being rotated at a high speed, and the fragments may punch through the holes 106 and 108 and the panel 104 owing to the soft material, plastic, of the panel 104. In short, the prior art disc drive 100 not only generates noise, but it is also unsafe.

### SUMMARY OF THE INVENTION

It is therefore a primary objective of the claimed invention to provide a disc drive capable of decreasing noise.

According to the claimed invention, a disc drive comprises a housing, a workbench, and a panel. The housing comprises an opening, a protection plane, a baffler plane formed on a side of disc ejection and extended from one edge of the protection plane, a support plane extended from the baffler plane, and a flange extended from the support plane. The workbench is installed inside the housing for performing corresponding functions. The panel comprises a first fillister corresponding to the support plane and a second fillister corresponding to the flange on the side of disc ejection for covering the opening of the housing. A length of the support plane is approximately equal to a width of the protection plane, and neither the baffler plane nor the support plane comprise a hole.

According to the claimed invention, a disc drive comprises a housing, a workbench, and a panel. The housing comprises an opening, a protection plane, a baffler plane formed on a side of disc ejection and extended from one edge of the protection plane, a support plane extended from the baffler plane, and a flange extended from the support plane. The workbench is installed inside the housing for performing corresponding functions. The panel comprises a first fillister corresponding to the support plane and a second fillister corresponding to the flange on the side of disc ejection for covering the opening of the housing. A length of the support plane is approximately equal to a width of the protection plane, and both of the baffler plane and the support plane are solid and intact.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art disc drive.

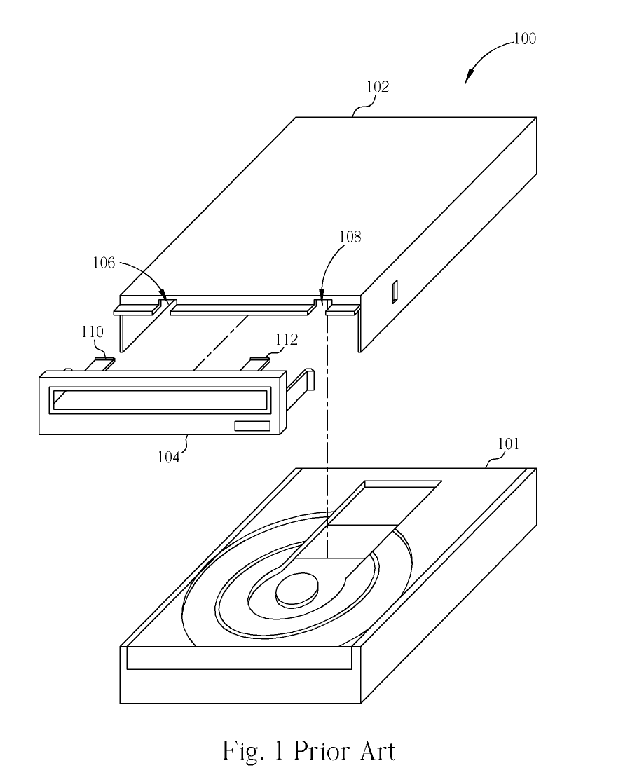

FIG. 2 illustrates a cross-sectional diagram of the disc drive shown in FIG. 1.

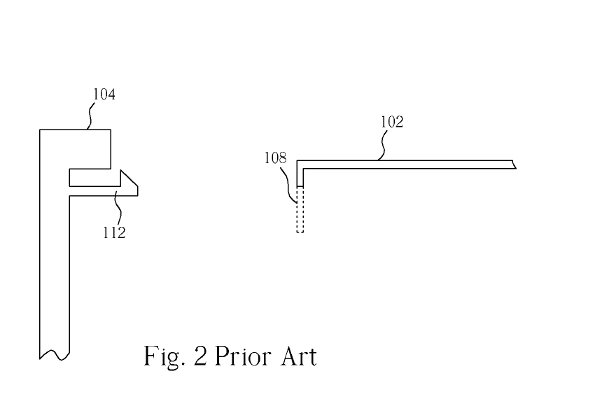

FIG. 3 illustrates a schematic diagram of a disc drive in accordance with a first embodiment of the present invention.

FIG. 4 illustrates a cross-sectional diagram of the disc drive shown in FIG. 3.

FIG. 5 illustrates a schematic diagram of a package case in accordance with a second embodiment of the present invention.

FIG. 6 illustrates a cross-sectional diagram of the package case shown in FIG. 5.

FIG. 7 illustrates a cross-sectional diagram of a package case in accordance with a third embodiment of the present invention.

### DETAILED DESCRIPTION

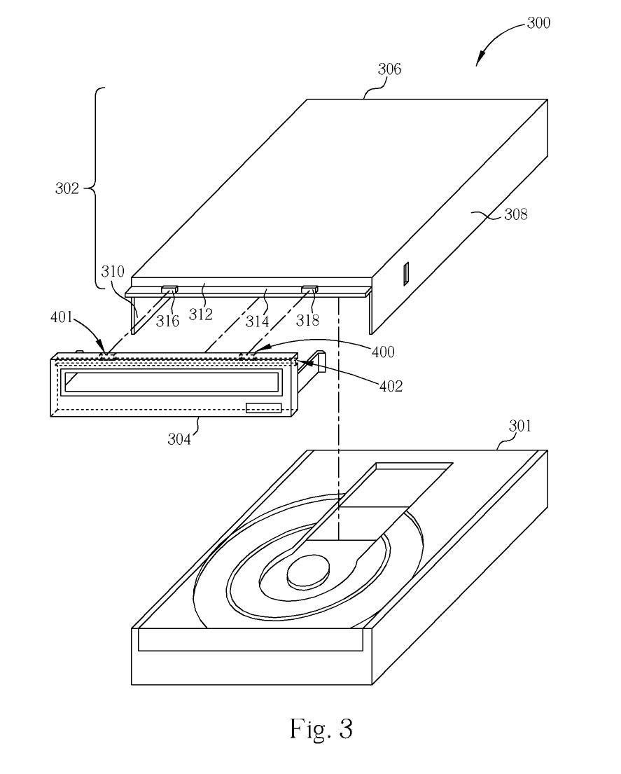

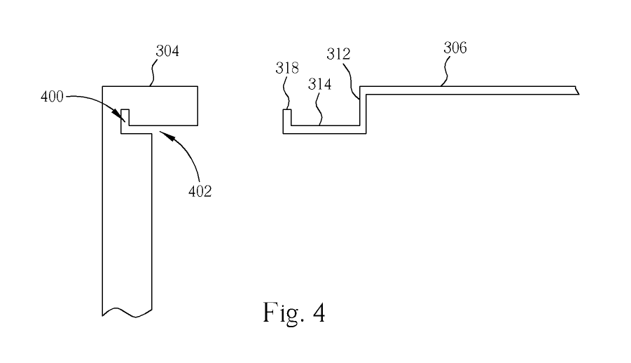

Please refer to FIG. 3, which illustrates a schematic diagram of a disc drive 300 in accordance with a first embodiment of the present invention. To be precise, FIG. 3 shows corresponding positions of a workbench 301, a housing 302, and a panel 304 in the disc drive 300. The housing 302 wraps the top and laterals of the workbench 301, and includes a protection plane 306, a first lateral plane 308, a second lateral plane 310, a baffler plane 312, and a support plane 314. The housing 302 can be made of metal, and is a whole-shape structure, or structures composed by welding, agglutination, etc. The protection plane 306, the first lateral plane 308, and the second lateral plane 310 wrap the top and laterals of the workbench 301. The baffler plane 312 is formed on a side of disc ejection and is extended from one edge of the protection plane 306. The support plane 314 is extended from the baffler plane 312, and includes flanges 316 and 318 in its edge. The flanges 316 and 318 are perpendicular to the support plane 314, and are utilized for fixing the panel 304. The panel 304 includes fillisters 400 and 401 corresponding to the flanges 316 and 318. Moreover, the panel 304 further includes a bar fillister 402 for holding the support plane 314. Therefore, by inserting the support plane 314 and the flanges 316 and 318 into the fillisters 402, 400, and 401, the panel 304 is fixed on the housing 302. Notice that, neither the baffler plane 312 nor the support plane 314 include any hole, or both of the baffler plane 312 and the support plane 314 are solid and intact, so the baffler plane 312 and the support plane 314 can prevent wind shear noise, especially when the workbench 301 operates at a high speed. Please refer to FIG. 4, which illustrates a cross-sectional diagram of the disc drive 300 along with centers of the flange 318 and the fillister 400. In FIG. 4, the fillister 400 corresponds to the flange 318, and the fillister 402 corresponds to the support plane 314. Therefore, by the fillisters and lateral hooks of the panel 304, the panel 304 can fix on the disc drive 300 firmly without agglutination or adhesive. As a result, the present invention can increase airtightness between the panel 304 and the housing 302, increase efficiency of manufacturing, decrease cost of production and noise, and enhance safety.

In comparison, when operating at a high speed, the prior art disc drive cannot insulate wind shear noise efficiently. On the other hand, in the present invention, neither the baffler plane 312 nor the support plane 314 have any hole, or both of the baffler plane 312 and the support plane 314 are solid and intact, so wind shear noise can be insulated. Moreover, the housing 302 made of metal is firmer, so fragments, generated by a broken disc when being rotated at the high speed, can be blocked by the baffler plane 312 to enhance safety. Furthermore, the panel 304 can fix on the housing 302 with the flanges 316 and 318, so as to enhance airtightness between the panel 304 and the housing 302, and decrease noise.

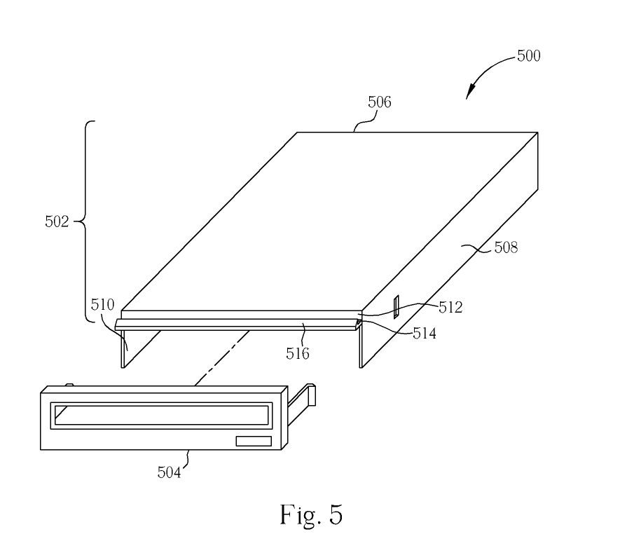

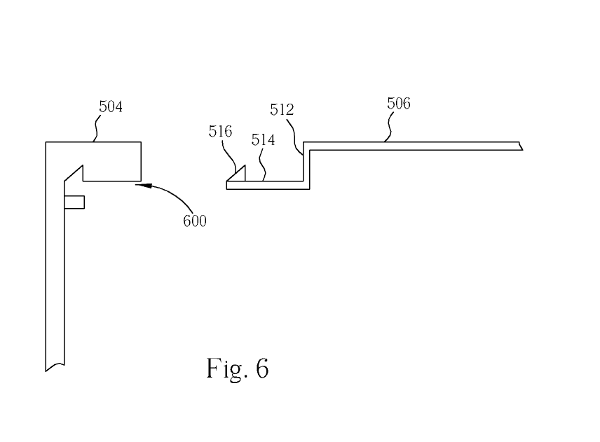

In the present invention, the flanges are not limited in any shapes and any locations as long as the panel can be fixed, and the baffler plane and the support plane are smooth along with the workbench. For example, please refer to FIG. 5 and FIG. 6. FIG. 5 illustrates a schematic diagram of a package case 500 in accordance with a second embodiment of the present invention, while FIG. 6 illustrates a cross-sectional diagram of the package case 500. The package case 500 includes a housing 502 and a panel 504. The housing 502 wraps the top and laterals of a disc drive, and includes a protection plane 506, a first lateral plane 508,a second lateral plane 510, a baffler plane 512, and a support plane 514. An edge of the support plane 514 includes a bar hook 516 utilized for fixing on the panel 504 through a fillister 600 of the panel 504 shown in FIG. 6. Therefore, by inserting the bar hook 516 into the fillister 600, the panel 504 can be fixed on the housing 506.

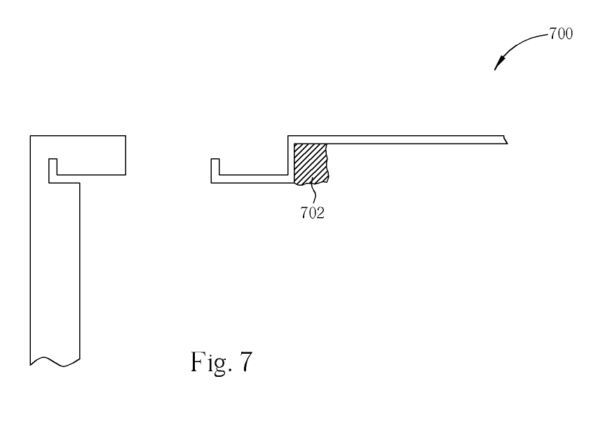

Furthermore, in the present invention, the baffler plane and the support plane can include materials for decreasing friction against the rotational plane in the sides facing the workbench, so as to decrease noise. Similarly, the baffler plane and the support plane can include layers of acoustic sponge or acoustic wool in the sides facing the workbench. Please refer to FIG. 7, which illustrates a cross-sectional diagram of a package case 700 in accordance with a third embodiment of the present invention. The package case 700 is similar to that of the disc drive 300 shown in FIG. 3 and FIG. 4, except that the cover 700 includes an acoustic sponge layer 702 in a side of the baffler plane facing the workbench. The acoustic sponge layer 702 absorbs noise, so as to decrease wind shear noise.

In summary, the present invention can insulate wind shear noise and enhance safety with the baffler plane and the support plane having no holes or with the solid and intact baffler plane and support plane. Also, the present invention increases airtightness with the flanges or the hooks, and does a better job of reducing noise with materials for decreasing friction or with the acoustic sponge layer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A disc drive comprising:
a housing comprising:
an opening;
a protection plane;
a baffler plane formed on a side of disc ejection and extended from one edge of the protection plane;
a support plane extended from the baffler plane; and
a flange extended from the support plane;
a workbench installed inside the housing for performing corresponding functions; and
a panel comprising a first fillister corresponding to the support plane and a second fillister corresponding to the flange on the side of disc ejection for covering the opening of the housing;
wherein a length of the support plane is approximately equal to a width of the protection plane, and neither the baffler plane nor the support plane comprise a hole.

2. The disc drive of claim 1, wherein the baffler plane is substantially perpendicular downward to the protection plane.

3. The disc drive of claim 1, wherein the baffler plane is substantially perpendicular outward to the support plane.

4. The disc drive of claim 1, wherein the flange is a hook like structure and substantially perpendicular upward to the baffler plane.

5. The disc drive of claim 1, further comprising acoustic sponge installed in a inner surface of the baffler plane.

6. The disc drive of claim 1, wherein the housing further comprises a first lateral plane and a second lateral plane formed in laterals of the disc drive and extended downward from the protection plane.

7. The disc drive of claim 1, wherein the protection plane, the baffler plane, the support plane and the flange are made in one piece.

8. A disc drive comprising:
a housing comprising:
an opening;
a protection plane;
a baffler plane formed on a side of disc ejection and extended from one edge of the protection plane;
a support plane extended from the baffler plane; and
a flange extended from the support plane;
a workbench installed inside the housing for performing corresponding functions; and
a panel comprising a first fillister corresponding to the support plane and a second fillister corresponding to the flange on the side of disc ejection for covering the opening of the housing;
wherein a length of the support plane is approximately equal to a width of the protection plane, and both of the baffler plane and the support plane are solid and intact.

9. The disc drive of claim 8, wherein the baffler plane is perpendicular to the protection plane.

10. The disc drive of claim 8, wherein the baffler plane is perpendicular to the support plane.

11. The disc drive of claim 8, wherein the flange is a hook corresponding to the second fillister.

12. The disc drive of claim 8, wherein the baffler plane comprises acoustic sponge.

13. The disc drive of claim 8, wherein the housing further comprises a first lateral plane and a second lateral plane formed in laterals of the disc drive and extended from the protection plane.

14. The disc drive of claim 8, wherein the baffler plane is made of metal.
